(19) United States
(12) Patent Application Publication
(10) Pub. No.: US 2025/0190592 A1
(43) Pub. Date: Jun. 12, 2025

(54) Service Security Control

(71) Applicant: Varonis Systems Inc., New York, NY (US)

(72) Inventors: Ron Sne, ATLIT (IL); Amir Belgi, RA'ANANA (IL); John Eugene Neystadt, KFAR-SABA (IL)

(21) Appl. No.: 18/537,595

(22) Filed: Dec. 12, 2023

(51) Int. Cl. G06F 21/60; G06F 40/30

(52) U.S. Cl. CPC G06F 21/604; G06F 40/30

(57) ABSTRACT

A system for managing access to services in a computing system. The system includes processes to allow users to request access to services, and the automated review of such requests. The system is configured to consider a wide range of factors, including the content of the request and the service requested, information relating to the user, and metadata relating to the service, as well as user behaviours. Natural language analysis is utilised to analyse a user's request for access and the service to which access is requested.

### TECHNICAL FIELD

The following disclosure relates to a system for controlling access to services within a computing system.

### BACKGROUND

Computing systems operated by organisations provide a wide range of services to their users. Services may be provided in the form of software running on a user's computer (or remotely) which allows them to perform certain actions, for example an email system providing email services. Also, services may be in the form of local or remotely accessible database systems such as a Customer Relationship Management (CRM) system which allows users to access and maintain data in relation to client interactions.

A large range of security restrictions apply to access to services to ensure users have access to services they require and are permitted to use, but cannot access services they should not. Relevant security restrictions depend on the type of services being considered. For example, for an email service the restrictions may control what actions are available (send, delete, move) or to whom a user can send emails, or for a CRM system restrictions may relate to which records, or which types data within a record, can be accessed.

The correct setting of security restrictions is currently a largely manual task, and/or relies on placing users into relatively large groups with standardised permissions. This is inefficient as correctly allocating permissions can be time-consuming, and grouping users limits flexibility and the ability to tailor permissions for each user. Furthermore, updating a when a user's permissions when their requirements change is time consuming for the system administrator and can lead to human error in assessing requirements and correctly updating permissions.

Existing systems for providing service security control relying on human intervention are therefore inefficient, while existing automated, computer-based, systems which seek to address the limitations of human involvement are often too simplistic and are limited in the complexity of the systems they provide.

There is therefore a need for service security control system which avoids the limitations of previous systems.

### SUMMARY

The invention is defined by the following disclosure and the claims.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding:

FIG. 1 shows a flow chart of a security control method according to the current disclosure;

FIG. 2 shows an exemplary set of modules and systems for implementation of the current disclosure; and

FIG. 3 shows modules and illustrative implementation of the current disclosure.

FIG. 4 shows an example of a computing device according to the current disclosure.

### DETAILED DESCRIPTION

The present disclosure relates to service security control systems for controlling users' access to services provided by a computing system of which they are a user.

In the following disclosure various techniques for controlling access to services are described which are intended to address shortcomings with previous systems. The described service security control system utilises computer-based analysis of language and parameters to determine whether a user's request for access to certain services should be permitted.

The term service is used in the following disclosure to describe a function provided for the computing system. That may relate to the overall functionality of a application, such that access is controlled to the whole application, or could be a subset of functions provided by a program such that a user has access to some functionality but not other functionality of an application.

Each of the techniques utilises multiple parameters and elements to decide whether a user should be provided access to particular services. The techniques may be triggered by a user requesting access to a service, by another user requesting a first user be given access, or by an automated system or process. In summary, when a user wants to use a certain service to which they do not currently have access they enter details of the service to which access is required, and a natural language explanation of why access is required and of the functionality of the service they are requesting access to into a request module of the computing system.

The request module transmits the request and explanation to an analysis module which compares the request with the service and various parameters to determine whether access should be granted. The analysis module performs an analysis of the natural language explanation and the service to determine whether they are sufficiently similar. In particular, the module compares the user's justification for access, which includes what functionality the user thinks the service will provide them, against the actual functionality provided by the service. The analysis module may be implemented using a Large Language Model (LLM), which is particularly trained for the type of analysis to be performed.

The analysis module may also consider a wide range of parameters relating to the user and services when deciding whether to grant access, in addition to the natural language analysis. Based on all aspects analysed the analysis module determines whether a threshold has been reached to permit access. For example, the analysis module may also consider factors such as whether peers of the user have access, or whether the service relates to a particular project to which the user is assigned.

The service security control system then modifies permissions for the service accordingly, and may notify the user and/or service owner of the outcome. The actions taken to modify permissions will depend on the nature of the service. For example, where the service is access to a whole application or program, that application may be installed for the user, or access for the user activated. Where the service is functionality within an application the configuration of the application may be updated to adjust the functions accessible by the user. In further examples the user could be provided with passwords or access codes to allow them to access the services.

Where the service security control system decides to decline access to the service the user is notified, and the owner or controller of the service may also be notified. The notification that access has been declined may indicate why the control system declined the request. As set out in further detail below, all requests and decisions are logged in an audit system to allow later review. Such audit logs may also be utilised as inputs for later requests to guide an LLMs behaviour in responding to such future requests. The audit log requests could also be reviewed and labelled to be used as further training data.

Prior to describing various techniques in more detail a set of categories of types of information that may be considered by the system are set out to aid the reader's general understanding. The details provided in each category are given by way of example only, and further details will be described below in a non-exhaustive manner.

A first category is the type and functionality of the service being requested, as well as the data to which the service will provide access. For example, the service may be an accounting application which stores accounts information for clients, and although a user may be permitted access to the accounting application, access to certain clients' data in the system may be prevented. The service could be access to a distribution list of email addresses comprising a large number of people. In such an example there may be no data access to consider, but only the functional aspects of enabling a user to email a large number of people. The type and functionality of the service may be determined by a textual description of the service or function, by analysing requests or data sent to or from the function, or from pre-stored details created manually or automatically from knowledge of application details or addresses. In many services, for example web-based services, requests and communications can be textual and are often structured (e.g. using the JSON data structure). Other communication protocols may also be textual, or it may be possible to analyse other formats such as binary. Details of the type of service may also be created by the resource owner when they create and configure the system.

A second category of information that may be considered is the role of the user (unless otherwise specified, in the following disclosure “user” will generally mean “the user requesting access”) or other characteristic of their position or responsibilities within the organization. For example the user's group in the organization may be compared to groups for which the service has been identified as being relevant.

A third category of information is metadata associated with the service to which access is being requested. For example that metadata may include specific security provisions relating to the service or data accessible via it.

A fourth category is technical information relating to users' behaviour and access within the computing system. For example, if the system determines a user has access to closely related services (for example different sets of data within an application) and frequently uses those services, that may be a flag that access should be provided. Similarly, if peers of the user have access to the service, or are responsible for it, this may indicate access should be granted.

The system may be configured to provide a weighting to each factor that is considered such that an overall view or score can be obtained for a request. The weight given to each parameter may be configurable to allow priorities to be varied by user, implementation, or even based on the service being considered. For example, services which include customer-related information may place greater weight on whether the user's responsibilities relate to that client, whereas services providing general functionality or allowing access to general commercial information may place more emphasis on a person's role (sales or technical).

Use of one or more of the categories of information above may enable access requests to be analysed and decided without requiring the intervention of any users, thereby improving efficiency and also allowing a more comprehensive and accurate consideration to take place that is not possible for a user to conduct. This improved review is not only limited to improving the speed at which a review can be conducted compared to a human user, but also allows implementation of steps that would not be possible for human user. For example, the computing system can consider a user's behaviour with regard to access to services, and can review a wider range of parameters than is possible for a user. Furthermore machine intelligence can be utilised to improve the accuracy and detail of the review, which may be able to identify patterns and situations which would be missed by a human user.

Typically the current disclosure is for implementation in a networked computing system in which a plurality of computers are networked. Users and services may be widely dispersed, and users requesting access to services may not have any direct relationship to the creator, owner, or manager of the service. It is therefore not possible for the creator, owner, or manager of the service to make a full assessment whether the user should be entitled to access. However, the current disclosure sets out techniques whereby the computing system can obtain sufficient information to be able to make a meaningful assessment.

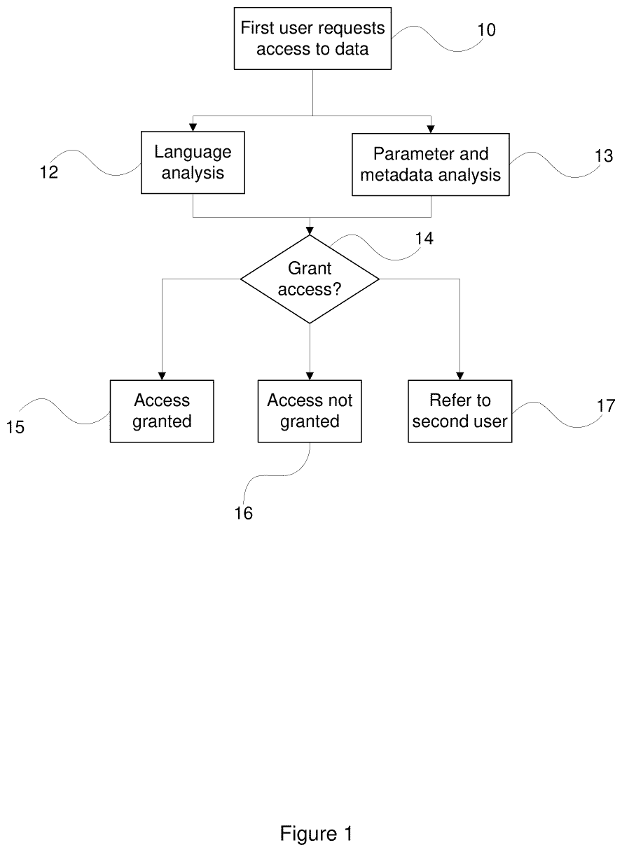

FIG. 1 shows a flow chart of a computer-implemented security control system which may address the drawbacks associated with previous systems. In particular the method of FIG. 1 uses the computing system's access to data and analysis capabilities of the computing system to arrive at a decision in a more efficient manner and while considering a wider range of parameters and details than is possible with a human-based process.

At step 10 a first user requests access to a service to which they do not currently have access. The request includes a natural language explanation from the first user why they need access to the service and what functionality the user believes the service will provide to them. The explanation may also include details such as which parts of data accessible by the service the user will require. For example, where the service is a CRM system the user may identify that application as well as particular clients to which access is required. The access request may be made in preparation for needing to use the service, or can be made at the time service is required. For example, a user may desire to send an email in an email system to a distribution list to which they do not currently have access. The user may first prepare the email to send and include the email in the request for access such that it can be analysed with the request.

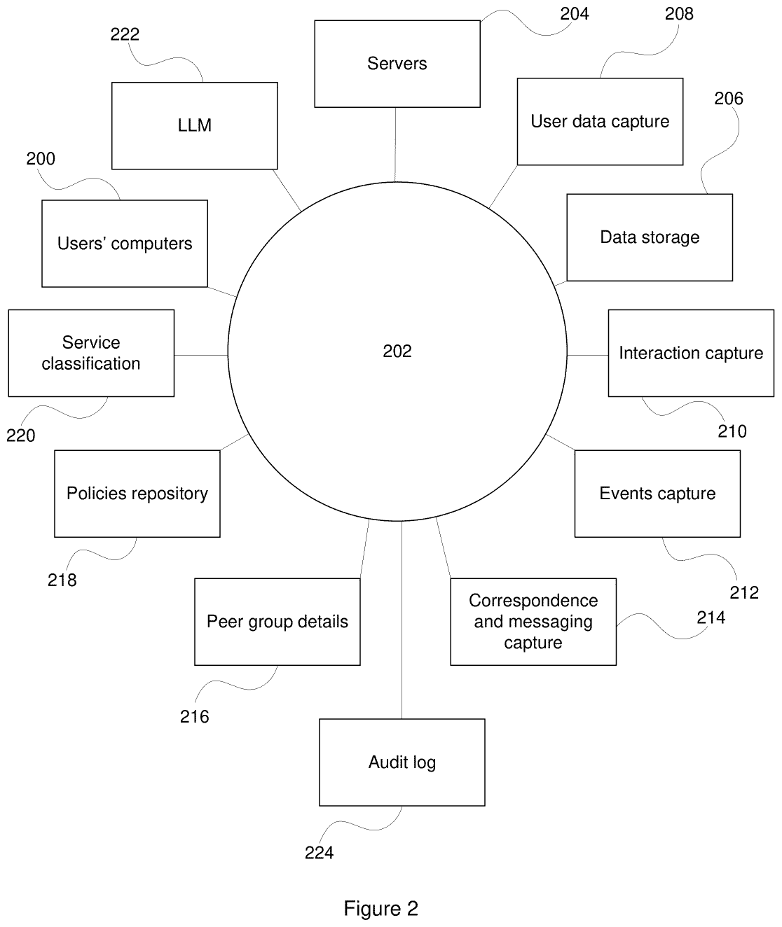

At step 12 & 13 the security control system begins analysis of the request to determine whether it should be granted, which analysis comprises two general types. At step 12 a language-based analysis of the user's reasons for requiring access and their summary of the service and data is performed and compared to an analysis of the service. At step 13 a review of parameters and metadata relating to the user and service is performed. In FIG. 2 these types of analysis are shown in parallel, but they may be performed in any appropriate manner, either in parallel, series, or a mixture. Certain elements of each analysis may overlap or feed results into the other analysis hence a mixed or even iterative execution could be utilised. In certain implementations language and parameter analysis could be considered as a single process conducted by a single entity.

In step 12 a language analysis system, for example a Large Language Model (LLM), is utilised to analyse the content of the user's request and the service. As set out above this analysis may be based on a textual description of the service or textual elements of the requests or communications related to the service, which may also be supplemented by details relating to the user and the address of the service. For convenience the term LLM will be used in the description of this process, but as will be appreciated any type of language analysis system could be utilised. The LLM may be trained using a set of annotated previous requests and their outcomes. The LLM may also contain knowledge of the relevant security domains and principles, as well as a prompt engineering process to provide the required context and related information to the LLM to take a decision. The annotations may include details of which parameters were considered important in the decision, and/or which elements of the natural language request were considered important.

The LLM analyses the user's explanation for the request and the service to determine at step 14 if it is appropriate for the user to be given access to the service. The system could also decide to provide different, for example more limited access, than is request. For example, if the service request is for general access to a CRM application, the system may decide to only grant access to that service in relation to certain parts of the data such as clients relating to the user. Where the request and related changes are directed to changing permissions within the service, rather than access to the service itself, the changes may be implemented utilising an API for the service which provides external functionality to modifying permissions within the service.

In relation to the user's request the LLM will analyse aspects such as the user's summary of the functionality they believe will be provided by the service, details regarding the user's role such as job title or position, their group and responsibilities, and context of the person's position (for example, a low-level assistant, but to a senior finance person).

The LLM compares the analysis of the user's reasons for the request and the service content to determine a similarity score for use in determining whether access should be provided. The similarity score is a metric of how similar the user's request is to functionality of the service. Thresholds may be set for the similarity score to use it to determine whether access should be provided.

The use of the LLM to compare the user's request for access with details of the service allows the system to make an accurate decision on whether to provide access.

Parameter analysis at step 13 provides greater detail and depth to act in conjunction with the LLM analysis. The parameter analysis is utilised to analyse aspects of the request and service which do not need an LLM to analyse, but can be done using more conventional data analysis techniques.

Parameters which may be analysed include the type of service (CRM, communications, etc), the type of data to which access might be enabled (public, client information, finance, sensitive etc), the user's team compared to the controller of the service or groups indicated as being the intended users, the location of the user, the user's general access permissions in relation to permissions relating to the service, groups of which the user and/or service are members, and peer group memberships in relation to the service. Further details of the types of parameters that may be considered are set out below.

When the LLM is called details of previous decisions made by humans may also be included in the prompts to the LLM (a technique often known as Retrieval Augmented Generation). Those previous decisions may be obtained from the audit log, as explained elsewhere, based on the user, the service requested, or any other parameter which may be related to previous requests.

At step 14 the security control system takes a decision whether access should be granted based on the LLM and/or parameter analysis performed at steps 12 and 13. The security control system decides whether to grant access based on an overall score of the various elements considered. Different weights may be applied to different elements depending on which elements are considered most important. For example, for services relating to internal functionality, such as internal communication systems, the match between the user's justification and the functionality may be considered more important than the user's level in the organization and given more weight, whereas for access to confidential financial information in a CRM system the user's level may be considered more important and given more weight. An overall score is thus formed and compared to a threshold determined for the system, which may be standard or may be dependent on aspects of the user or service. The threshold score may be dependent on the type of service or value or importance of the data to which the service enables access.

Certain parameters may be configured in a binary fashion such that if they have a certain value access will not be provided irrespective of any other assessment. For example, services which allow access to legal matters may only be accessed by members of the legal group.

The score used to decide whether to grant access can be calculated in various ways. For example an absolute value could be utilised such that the total of the weighted assessments has to exceed a certain value to be approved. Alternatively a confidence score could be utilised to express how certain the system is that access should be provided. For example, this could be expressed as a percentage with 100% representing a very clear decision to provide access and 0% a very clear decision not to. The system would be configured with a threshold above which access would be provided, which threshold may be configurable.

The security control system can take various decisions in relation to the user's request. Access may be granted at step 15 and a notification sent to the user. Access may be provided by the security control system updating permissions for the service directly, or by sending commands to the application or other management modules of the computer system. Also, as noted above, the user could be provided with log-in credentials or access codes for the new service. The notification may include the LLM's reasons for granting the access, and may also be sent to the owner of the document. The access granted may also be modified compared to that requested, for example by limiting the service or data which can be accessed by the service.

The security control system may decide the user is not permitted access in which case at step 16 a notification is sent to the user, they are not provided with access, and the services provider or owner may be notified of the failed request. The owner and/or user may be notified of the reasons for the LLM's decision. Alternatively at step 17 the security control system may consider the correct outcome is not clear and the request is referred to a second user, for example the service's owner or provider, or other person tasked with making access decisions, for a decision in which case the first and second users are notified and access is not provided. A user's input may be required for particularly sensitive services, based on a user's characteristics or parameters, or where the overall outcome from all weighted aspects is too closely balanced to be able to decide automatically. The threshold for allowing an automatic decision may be configured based on details of the user requesting access, or the service to which access is being requested. When a request is referred to a second user to decide, the second user's decision is stored in the audit log and may be utilised by the LLM when considering future similar requests.

The process described with reference to FIG. 1 therefore allows a decision to be taken by the computing system regarding a service access request by a user. The decision is taken based on an analysis of the content of the request and the service, and other parameters. The analysis and decision is performed without any user intervention allowing an improvement in the speed, accuracy, and scope of the parameters considered when taking the decision. Only where the analysis reveals a need for a user to take a decision is human intervention required. The user's efforts are thus reduced and focused on the more difficult decisions.

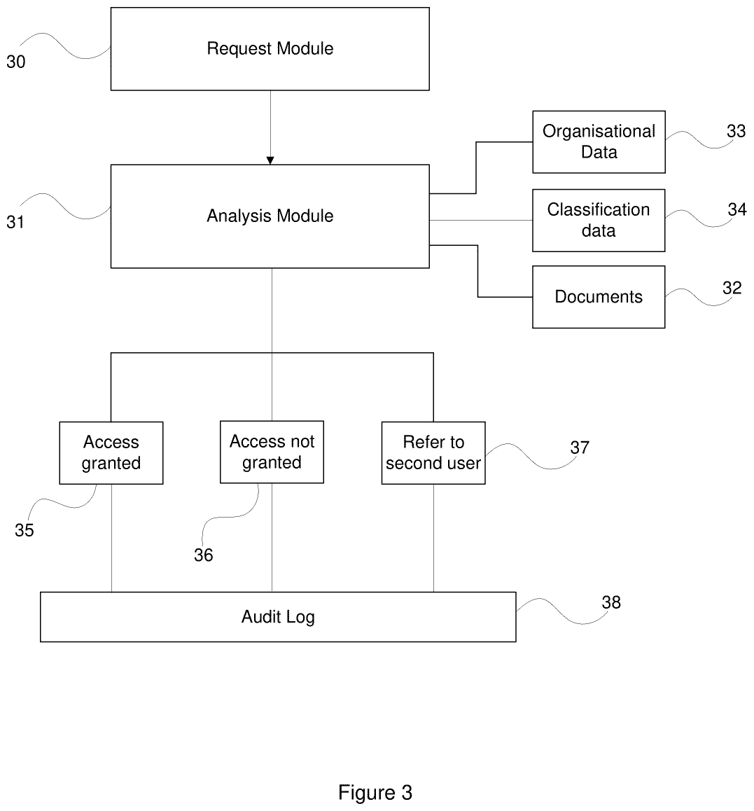

Further details of the system and implementation of the method of FIG. 1 will now be discussed. FIG. 2 shows an exemplary overview diagram of hardware, computer-implemented elements, and functions of the computing system in which the system may be implemented. In general the computing system will comprise a plurality of user's computers 200 connected via a network 202 with a plurality of servers 204. The network 202 enables sharing of data and instructions between the user's computers 200 and the servers 204. As set out below the user's computers 200 and servers 204 provide a range of functionalities to enable implementation of the security control system. The servers 204 may also provide access to applications and services to which users require and request access. For example, servers 204 may provide web-access servers, databases, remotely-accessible applications, and any other service that a computing system may provide to users. The separation of functionalities shown in FIG. 3 is purely for ease of explanation and there is no limitation to how those functionalities are divided between software and hardware entities. Each function may be provided by a separate hardware or software system, or may be split across multiple such systems.

File storage module 206 represents the storage of files to which user's may require and request access. File storage module 206 may represent any storage type of a computing system. For example, files may be stored on a user's computer, on network attached storage, dedicated file servers and document management systems, or networked file management systems and cloud-based storage systems. As noted above, any type of file may be stored, but will principally comprise documents. Metadata and parameters defining the files may be stored to provide additional information on each file or document. The file storage system may also store information regarding access rights which are updated by the security control system (or other process), or those access rights may be stored separately. In addition the storage location and path may be used to identify further information about the document. As explained in the applicant's co-pending application Ser. No. 18/494,631, which is incorporated herein by reference, similar security processes to those described in the current application may be applied in relation to files stored by file storage module 206.

User data capture module 208 captures and stores information regarding users who have access to the system, such as organizational information, titles, departments and reporting lines, and group memberships. The data may be used to build a structure tree of users. The system may capture such data from routine scanning of personnel management systems, directory systems (Active Directory/Azure Active Directory), or from manual entry. The user data information allows identification of a user's teams and related people which may be useful in determining how to handle service access requests.

The interaction capture module 210 gathers information regarding which users are interacting with other users within the computing system. This may primarily be gathered from ticketing and workflow management systems, but also from communication systems. Interaction data enables the security control system to infer the relevance of services to a user based on the access provided to other users they are interacting with.

The events capture module 212 captures interactions of users with files and services within the computing system. For example, the module may log all access to services and files by each user which enables identification of groups of services to which certain users may require access. For example if the module determines that users often access a set of services {a, b, c, d, e} but the requesting user only has access to services {a, b, c, d} a request for access to service {e} may be implied to be reasonable and allowed. Similarly, in conjunction with the interaction and peer module it may be determined that the requesting user has strong interactions with another user who has permission to access service {e}. This may indicate access should be granted. The events capture module may also monitor user's behaviour in a more general sense. For example, if there is a sudden increase in the number of requests, the person's position in the organization has changed, or they have stated they are leaving, may all affect the decision whether to provide access. It is unusual for a user tasked with reviewing access requests to be aware of such changes. Dynamic events may be particularly relevant to deciding whether to grant access as they imply something has changed. That change may support a request for a access (for example a user moving to a different team and therefore requiring access to different services), or guide against it (a user has indicted they are leaving).

The messaging capture module 214 analyses communications between users, for example email and instant messages, in order to determine relationships and interactions between users which may provide an indication of whether a user requires access to particular services. For example this analysis may reveal correspondence between a user who already has access to a service and a user who has requested access to that service which implies access should be allowed. A language analysis system may also be utilised to analyse communications in order to determine their meaning and content which may provide additional guidance on whether a user requires access to services.

The peer group module 216 utilises any aspect of the computing system to determine a user's peer group which may provide additional information on whether a user requires access to services. The user's peer group may be determined based on groups setup within the communication system, the user's position within the organizations structure, and other modules within the system. For example, the communication analysis module may also reveal information about a user's peer group. A user's peer group may be dynamic and evolve over time as the user works with different teams or on different projects.

A policies module 218 stores configuration information regarding the review and grant of access requests. Policies may include details of which types of services can be approved automatically by the system, which types always require user input, and weighting and thresholds of the different parameters. Configurations may be the same for a whole organization or may also be defined on a user, group, or other basis. For example, the system behaviour may be depend on the security level allocated to services and on the level of the user requesting access.

Service classification module 220 classifies services based on their sensitivity, confidentiality, or other aspect of the service, for example what data they may enable access to. The classification may be applied manually by users during service creation or at another stage in the service's life, or may be applied automatically by a classification engine which determines the classification based on, for example, service content, functionality, or data access provided.

Each of the modules discussed herein which gather information on users and the system may operate on a continuous basis, or run on a schedule, to maintain a current view of the relevant parameters. This ensures that requests are considered against the current circumstances thus maximising accuracy.

As discussed above the LLM module 222 analyses services and a user's justification for requesting access to understand their functionality and access provided. The LLM also has access to all other and information discussed herein to utilise in its analysis. The output of the analysis is used to compare the justification and services to determine whether the user should be provided with access. The LLM may analyse the service's actual features as well as the user's view of those features which may indicate whether the user's expectations match reality, or if they are attempting to gain access to services by misrepresentation (accidental or otherwise). The LLM may be trained based on example requests and services, as well as the outcome of previous decisions whether to provide access. As outlined above the LLM will also be provided with relevant knowledge of the security systems and domains applicable to each installation.

The LLM may be termed a “fine-tuned” LLM since it has been trained for the specific tasks performed by the security control system. The LLM may be trained on previous requests which have been labelled appropriately for use in training or fine-tuning. The aim of the training process is to understand what a human user would do in a particular situation and train the LLM to take the same decisions. These principles apply to all aspects of the decision process and service which is considered in that process. As noted below, when a human user assists in a decision they may provide a natural language explanation which can be used to train the LLM. These previous decisions may be used in the prompts passed to the LLM for future requests.

Audit log module 224 receives and stores information on each process conducted by the system to allow later auditing, and also for use by the security control system when considering future requests. Each user request is logged together with details of the outcome of the request. The amount of detail stored in the log may be configurable to only store high-level details of the request and outcome, or the specific inputs, outputs and reasons may be stored. The latter more detailed storage has the benefit of enabling the decisions to be used to train the system for future requests and provide more information on which to base future similar requests. The audit log may be stored in a format which works efficiently with LLMs, for example a Vector db structure. For example, when a specific service is requested by a user the system may review the audit log 224 for previous decisions relating to that service to guide how to decide the new request. This may be particularly helpful, for example, if the same user requests a service to which they have previously been declined access. When a request is referred to a human user for a decision the user may enter a natural language explanation of the reasons for their decision. That natural language explanation may be utilised by the analysis system when taking future decisions.

FIG. 3 shows an overview of how selected elements of FIGS. 1 and 2 interact during the processing of a user's request for access to a service. The process starts at block 30 in which a request module receives a user request for access to a service, which request includes a natural language description of their reasons for requesting access to the service, and the user's summary of the functionality of the service.

Block 31 represents an analysis module which performs the analysis of the service, the user's request, and other parameters to determine whether access should be allowed. The module 31 may calculate a similarity score between the service 32 and the user's justification which is compared to a configured threshold to determine whether access should be allowed. The block 31 also takes input from the modules discussed above with reference to FIG. 2, for example organizational data 33 from directory systems, and/or service classifications 34 from a classification store.

Based on the analysis in block 31, and comparison of scores and parameters, the module 31 determines whether access should be granted 35, denied 36, or referred to a second user for human review 37. Any or all aspects of the process may be stored into an audit log 38 such that a record is kept of decisions taken by the system, and of the parameters behind that decision.

Set out below is an overview of examples in relation to specific service types, following by examples of request processing in relation to those services. These processes and examples are for illustrative use only, and are not intended to restrict the parameters considered, nor to specify the outcomes will always be as described.

A fine-tuned generative AI model is created by training a foundation model with a large set of examples created by a human. The training request situations are captured in documents describing the request, expected outcomes and justifications. Specific details which may be in the documents are:—
a. User justification for being granted access.
b. User data-title, time in the organization, user's past behaviour.
c. Peer data-peer group, do peers have access have to the service.
d. Service data-functionality, data access provided, other people with access to the service, and past access history.
e. Past requests for the service, decisions, and in particular decisions by humans.
f. The weighting of different parameters to be considered.

### Email

Typically all users have general access to email systems as they are an essential element of conducting a role. However, aspects of the email service may be restricted to certain users. For example, the ability to email large numbers of users using a distribution list may be limited to avoid accidental or deliberate mass emails. Although this example is given in relation to email services it applies equally to all communication systems including instant messaging or chat services.

As set out above the LLM analyses the user's natural language justification for access, as well as elements of the system. Specific parameters and context which are relevant to a request to send an email to a distribution list to which the user does not have access include:—
1. User data defining the user's position in the organisation, which may in an example be obtained from an active directory system, including:—
   1. User's Role: What is the role and level of the user in the organization? Higher-level employees, or those involved in management, may have more privileges and be granted more access.
   2. User's Department: Which department does the user belong to? Some departments might have more need to send company-wide emails.
   3. User's Tenure: How long has the user been with the company? Longer-tenured employees might have more trust.
2. Email Content: access to the service may be requested supported by an email which the user wishes to send. The LLM system may review the content of the email to determine whether it is appropriate, for example in terms of language and content, to send to the requested distribution list.
3. Frequency of Requests: How often does this user send emails to the distribution list? If it's too frequent, it might be considered an abuse and rejected.
4. Time of Request: What time is the email being sent? Emails sent during working hours might be more likely to be approved.
5. Distribution List Size: How many people are in the distribution list? Larger lists might require higher scrutiny.
6. Previous Approvals: Has the user had previous requests approved or denied?
7. Purpose of Email: What is the purpose of the email? Certain purposes might be prioritized. This information may be determined from the LLM based on the user's request, or the content of the email.
8. Urgency of Email: How urgent is the email? The user may be permitted to indicate an urgency in their request which may enable certain checks to be overridden, but there must be confidence that the user is behaving correctly and the request is genuine.
9. Email Attachments: Does the email contain any attachments? If so, what type of files are they and what is their size? Certain types of files might be restricted, and larger files might require more scrutiny.
10. User's Past Behaviour: Has the user previously sent emails that were marked as inappropriate or that led to complaints? Past behaviour can be a good predictor of future behaviour.
11. Recipient Feedback: Has there been negative feedback from recipients about previous emails sent by this user to the distribution list?
12. Company Policies: Are there any company policies that might affect whether the email should be sent? For example, there might be policies about sending emails on certain topics or at certain times.
13. Company Events:
   1. For example, if the company is in a quiet period before an earnings announcement, it might restrict certain types of communication.
   2. If a major company event is happening (like an annual meeting or product launch), the system might prioritize related emails.
   3. The system can have access to a company events calendar or track meetings sent to all employees.

Access to the requested email service may be granted as a single event (for example to send a single email containing specified content to defined addresses), for a specified period, or indefinitely.

In a first example of a request for access to a distribution list in an email system a user who is a junior employee in the marketing department and has been with the company for 6 months requests to send an email to the company-wide distribution list. The email is about a charity event organized by the marketing department (as determined from the user's justification, and/or the LLM analysing the email). It is being sent during working hours and contains no attachments. This is the user's first time sending an email to the company-wide distribution list.

The user provides a natural language justification for their request of “I want to send this email to inform everyone about a charity event organized by our marketing department. I believe this event will boost our employee morale and foster a sense of community.”

The system may consider the following parameters in relation to the request:—
1. User's Role: Junior employee
2. User's Department: Marketing
3. Email Content: Charity event organized by the marketing department
4. Frequency of Requests: First time
5. Time of Request: During working hours
6. User's Tenure: 6 months
7. Purpose of Email: Inform about a charity event
8. Email Attachments: None
9. User's Past Behavior: No previous emails marked as spam or led to complaints
10. Company Policies: No known violations

The user provides a natural language justification for their request of “I want to send this email to inform everyone about a charity event organized by our marketing department. I believe this event will boost our employee morale and foster a sense of community.”

The system may assess some of these parameters as follows and determine that the request should be allowed:—
1. The email content is appropriate and related to company activities (charity event organized by the marketing department).
2. The email is being sent during working hours, which is typically acceptable.
3. The user has no history of sending spam or receiving complaints about their emails.
4. The user has not frequently sent emails to the company-wide distribution list (this is their first time), reducing the likelihood of it being considered spam.
5. There are no attachments in the email, reducing security risks.

In a second example a user who is an intern in the HR department and has been with the company for 1 month, requests to send an email to the company-wide distribution list. The email is about a personal blog post she wrote. It is being sent outside of working hours and contains a PDF attachment of the blog post. This is Jane's first request to send an email to the company-wide distribution list.

The user provides a natural language justification as “I want to share my personal blog post with everyone. I believe my post contains insights that could benefit my colleagues.”

Parameters the system may consider in relation to this request include:—
1. User's Role: Intern
2. User's Department: HR
3. Email Content: Personal blog post
4. Frequency of Requests: First time
5. Time of Request: Outside working hours
6. User's Tenure: 1 month
7. Purpose of Email: Share a personal blog post
8. Email Attachments: PDF of the blog post
9. User's Past Behaviour: previous emails marked as spam or led to complaints
10. Company Policies: No known violations

Analysing these parameters the system may reject the request because:—
1. The email content is personal (a blog post) and not related to company activities.
2. The user's role (intern) might not warrant sending emails to a company-wide distribution list.
3. The user's short tenure (1 month) might not warrant sending emails to a company-wide distribution list.
4. Time of Request: The email is being sent outside of working hours. This might be considered inappropriate or disruptive.
5. The email contains an attachment, which could pose a security risk.

### CRM System

In relation to requests for access to a CRM service the system may consider parameters such as:—
1. User data defining the user's position in the organisation, which may in an example be obtained from an active directory system, including:—
   a. User's Role: What is the role and level of the user in the organization? Higher-level employees, or those involved in management, may have more privileges and be granted more access.
   b. User's Department: Which department does the user belong to? Some departments might have more need to send company-wide emails.
   c. User's Tenure: How long has the user been with the company? Longer-tenured employees might have more trust.
2. Frequency of requests and Access History
3. Collaboration/Peers: Is the user currently collaborating with others who have legitimate access to this data?
4. Customer Sensitivity (e.g. special customers such as governments, important customer)
5. Details about the customer status

The requested access may be provided as a single event, for a specified time, or indefinitely.

In a first example request for access to a new customer in a CRM system the user may provide a justification that “I need to access the customer's purchase history to prepare for a sales call today.”

Relevant parameters assessed by the system in relation to this request may include:—
1. User's Role: Sales Manager
2. User's Department: Sales
3. User's Tenure: 3 years
4. Frequency of Requests and Access History: Frequently accesses customer purchase history
5. Collaboration/Peers: Currently collaborating with a team who have legitimate access to this data
6. Customer Sensitivity: Regular customer, not classified as sensitive
7. Details about the Customer Status: Paying customer

The system may analyse relevant parameters as follows and approves the request based on the analysis.
1. Justification: The user's justification for accessing the data aligns with their role as a Sales Manager. Preparing for a sales call is a legitimate reason for a Sales Manager to access a customer's purchase history.
2. Role and Department: As a Sales Manager in the Sales department, the user would typically have access to this type of data. Their role and department within the organization support her justification.
3. User Tenure and Access History: The user has been with the company for 3 years and frequently accesses similar data, which suggests that they are experienced and their request is in line with their usual activities.
4. Collaboration/Peers: They are currently collaborating with others who have legitimate access to this data, which supports their need to access it as well.
5. Customer Sensitivity and Status: The customer is not classified as sensitive and is a paying customer, which means there are fewer restrictions on accessing their data.

In a second example request for access for a new customers data in a CRM system a user may specify “I need to access the customer's purchase history to prepare for a sales call we might have.”
1. User's Role: Junior Sales Representative
2. User's Department: Sales
3. User's Tenure: 6 months
4. Frequency of Requests and Access History: Rarely accesses customer purchase history
5. Collaboration/Peers: Not currently collaborating with others who have legitimate access to this data
6. Customer Sensitivity: Regular customer, not classified as sensitive
7. Details about the Customer Status: Potential customer

Based on an assessment of these parameters the system may reject this request because:—
1. Premature Justification: While preparing for a sales call is a legitimate reason to access customer data, doing so in advance for only a potential call is unusual and may not be necessary.
2. Role and Department: As a Junior Sales Representative, the user does not have the same level of access as a manager or senior representative. Their role does not justify access to this type of data.
3. User Tenure and Access History: The user has only been with the company for 6 months and rarely accesses this type of data. This suggests that their request is not in line with their usual activities.
4. Lack of Collaboration: The user is not currently collaborating with others who have legitimate access to this data, which raises questions about why they need to access it.
5. Customer Status: The customer is only a potential customer, not a current one. There may be restrictions on accessing data of potential customers without a valid business reason.

### Proxy

In relation to proxy services the system may consider the following parameters to determine access requests:—
1. User data defining the user's position in the organisation, which may in an example be obtained from an active directory system, including:—
2. User's Role: What is the role and level of the user in the organization? Higher-level employees, or those involved in management, may have more privileges and be granted more access.
3. User's Department: Which department does the user belong to? Some departments might have more need to send company-wide emails.
4. User's Tenure: How long has the user been with the company? Longer-tenured employees might have more trust.
5. Peers' access to the website
6. Website reputation
7. Website web page description (title, html content)
8. Website category
9. Website's Relevance to Task: Is the website relevant to the task the user is trying to perform?
10. User's Past Security Incidents: Users with past security incidents might warrant more scrutiny when accessing websites.
11. Website's Terms of Service and Privacy Policy: Websites with clear and user-friendly terms and privacy policies are more likely to respect user data.
12. User's Device Security Status-Device which is not up to date is more exposed to risks in case the reputation of the website is low
13. Access Time Relative to User's Working Hours: If the user is trying to access the website outside of their normal working hours, it might warrant further investigation.

The requested access may be provided as a single event, for a specified time, or indefinitely.

In a first example of a request for access to a proxy service the user may provide a justification of “I need to access this website to gather some data for my project.” The system may asses the following parameters:—
1. User's Role: Project Manager
2. User's Department: Research and Development
3. User's Tenure: 5 years
4. Peers' Access to the Website: 10 peers have accessed the website in the past month
5. Website Reputation: Medium
6. Website Web Page Description: “Data Science Resources and Tutorials”
7. Website Category: Educational
8. Website's Relevance to Task: High (The user is working on a data science project)
9. User's Past Security Incidents: None
10. Website's Terms of Service and Privacy Policy: Clear and user-friendly
11. User's Device Security Status: Up-to-date
12. Access Time Relative to User's Working Hours: Within working hours

Based on these parameters the system may approve the request because:—
1. The user has a good tenure with the company, indicating trustworthiness.
2. The website is relevant to the task the user is trying to perform.
3. The website has a clear and user-friendly terms of service and privacy policy.
4. The access time is within the user's working hours, reducing suspicion.

In a second example request for access to a proxy service the user may provide a justification that “I need to access this website to download a software tool for my project.”:—
1. User's Role: Software Engineer
2. User's Department: IT
3. User's Tenure: 2 years
4. Peers' Access to the Website: No peers have accessed the website in the past month
5. Website Reputation: Low
6. Website Web Page Description: “Free Software Downloads”
7. Website Category: Software Downloads
8. Website's Relevance to Task: High (The user is working on a software project)
9. User's Past Security Incidents: Three incidents in the past year
10. Website's Terms of Service and Privacy Policy: Unclear and complicated
11. User's Device Security Status: Not up-to-date
12. Access Time Relative to User's Working Hours: Within working hours

Based on an analysis of these parameters the system may reject the request because
1. The website has a low reputation, indicating potential risks.
2. The website's terms of service and privacy policy are unclear and complicated.
3. The user has past security incidents, indicating potential irresponsible behaviour.
4. No peers have accessed the website in the past month, indicating it might not be a trusted source within the organization.
5. Even though the website is relevant to the task, downloading software from untrusted sources can lead to security issues.

The present disclosure has been given by reference to services to ensure a clear description. As set out in the applicant's co-pending application Ser. No. 18/494,631, incorporated herein by reference, similar principles may also be applied to services.

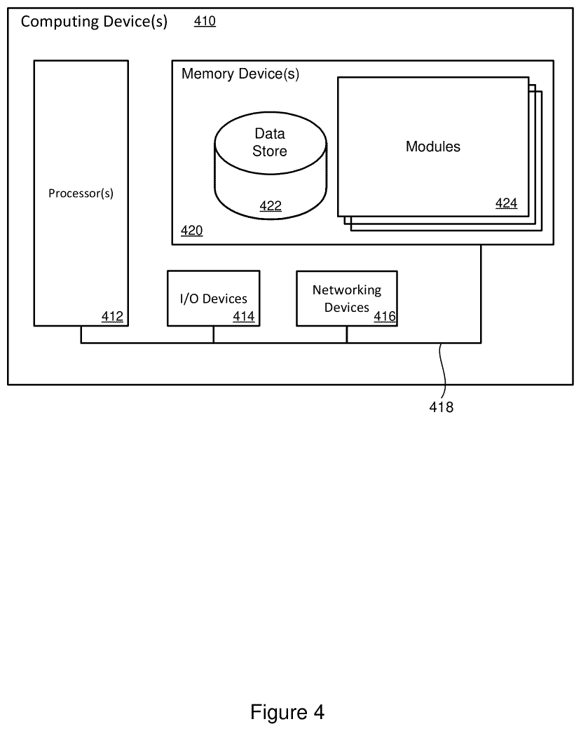

FIG. 4 illustrates a computing device 410 on which modules of this technology may execute. A computing device 410 is illustrated on which a high level example of the technology may be executed. The computing device 410 may include one or more processors 412 that are in communication with memory devices 420. The computing device 410 may include a local communication interface 418 for the components in the computing device. For example, the local communication interface 418 may be a local data bus and/or any related address or control busses as may be desired.

The memory device 420 may contain modules 424 that are executable by the processor(s) 412 and data for the modules 424. In one aspect, the memory device 420 may include a checkpoint manager, a migration management module, and other modules. In another aspect, the memory device 420 may include a network connect module and other modules. The modules 424 may execute the functions described earlier. A data store 422 may also be located in the memory device 420 for storing data related to the modules 424 and other applications along with an operating system that is executable by the processor(s) 412.

Other applications may also be stored in the memory device 420 and may be executable by the processor(s) 412. Components or modules discussed in this description that may be implemented in the form of software using high-level programming languages that are compiled, interpreted or executed using a hybrid of the methods.

The computing device may also have access to I/O (input/output) devices 414 that are usable by the computing devices. Networking devices 416 and similar communication devices may be included in the computing device. The networking devices 416 may be wired or wireless networking devices that connect to the internet, a LAN, WAN, or other computing network.

The components or modules that are shown as being stored in the memory device 420 may be executed by the processor(s) 412. The term “executable” may mean a program file that is in a form that may be executed by a processor 412. For example, a program in a higher level language may be compiled into machine code in a format that may be loaded into a random access portion of the memory device 420 and executed by the processor 412, or source code may be loaded by another executable program and interpreted to generate instructions in a random access portion of the memory to be executed by a processor. The executable program may be stored in any portion or component of the memory device 420. For example, the memory device 420 may be random access memory (RAM), read only memory (ROM), flash memory, a solid state drive, memory card, a hard drive, optical disk, floppy disk, magnetic tape, or any other memory components.

The processor 412 may represent multiple processors and the memory device 420 may represent multiple memory units that operate in parallel to the processing circuits. This may provide parallel processing channels for the processes and data in the system. The local interface 418 may be used as a network to facilitate communication between any of the multiple processors and multiple memories. The local interface 418 may use additional systems designed for coordinating communication such as load balancing, bulk data transfer and similar systems.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term “comprising” or “including” does not exclude the presence of other elements. Similarly the use of the singular does not exclude the plural and vice-versa.

The term “computer” or “computing device” is used herein to refer to any computing device which can execute software and provide input and output to and from a user. For example, the term computer explicitly includes desktop computers, laptops, terminals, mobile devices, and tablets, as well as any similar or comparable devices. There is no intended difference between the terms computer, computing system or computing device, all of which fall within the same definition of computer.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable storage media or, more generally, a computer program product. The computer readable storage media, as the term is used herein, is not to be construed as storage in the form of transitory signals per se, such as radio waves or other freely propagating electromagnetic waves. The one or more computer readable storage media could be, for example, an electronic, magnetic, optical, electromagnetic, infrared, or semiconductor system, or a propagation medium for data transmission, for example for downloading the code over the Internet. Alternatively, the one or more computer readable storage media could take the form of one or more physical computer readable media such as semiconductor or solid state memory, magnetic tape, a removable computer diskette, a random access memory (RAM), a read-only memory (ROM), a rigid magnetic disc, and an optical disk.

A selection of examples is set out in the following numbered clauses.

1. A computer system for a security control, comprising: one or more computer readable storage media storing program instructions and one or more processors which, in response to executing the program instructions, are configured to: receive user input requesting access to a service provided by the computing system, wherein the user input identifies the service and includes a natural language justification for requesting access; perform a language analysis of the natural language justification and identify a similarity score between the natural language justification and parameters of the service; determine whether access should be granted to the service based at least in part on the similarity score; and configure permissions for the service to enable access by a user when a determination is made to grant access.

2. A computer system according to clause 1, wherein the natural language justification comprises a description of what the user believes to be the functionality of the service.

3. A computer system according to clause 1 or clause 2, wherein the determination whether access should be granted is based at least in part on whether users related to the user have access to the service.

4. A computer system according to clause 3, wherein the users are related by being in a common group in a directory server.

5. A computer system according to clause 3, wherein relations between the users are determined based at least in part on communications between the users.

6. A computer system according to clause 3, wherein the relations between the users are determined based at least in part on organization data of an organization to which the users belong.

7. A computer system according to clause 3, wherein the relations between the users are determined based at least in part on interactions in workflow management systems.

8. A computer system according to clause 3, wherein the related users are based on access to the same service by the requesting user and other users.

9. A computer system according to any preceding clause, wherein the determination whether access should be granted is based at least in part on the user's access rights in relation to related services.

10. A computer system according to any preceding clause, wherein the determination whether access should be granted is based at least in part on the user's role in the organization which provides the service or the organisation to which the user belongs.

11. A computer system according to any preceding clause, wherein the determination whether access should be granted is based at least in part on a weighted score of a plurality of parameters including the similarity score.

12. A computer system according to clause 11, wherein the score weightings are dependent on the service and/or user.

13. A computer system according to any preceding clause, wherein the determination is based at least in part on previous network and service access by the user.

14. A computer system according to any preceding clause, wherein when a determination is made to not grant access, sending, by the processor, a notification to a user responsible for the service to take a decision.

15. A computer system according to any preceding clause, wherein the user input and decision are written to an audit log.

16. A computer system according to any preceding clause, wherein the determination is based at least in part on security settings of the service.

17. A computer system according to any preceding clause, wherein the determination is based at least in part on a classification of the service, as determined by a classification engine.

18. A computer system according to clause 17, wherein the classification is based on the sensitivity or content of data accessible using the requested service.

19. A computer system according to any preceding clause, wherein the determination is based at least in part on a creator or owner of the service.

20. A computer system according to any preceding clause, wherein information on which the determination is based is captured by the computer system and stored in at least one database for access by the computer system.

21. A computer system according to clause 20, wherein the information on which the determination is based is maintained on a continuous or intermittent basis by the computer system.

22. A computer system according to any preceding clause, wherein the language analysis is performed by a Large Language Model (LLM).

23. A computer system according to clause 22, wherein the LLM is trained on prior human decisions in relation to user requests.

24. A computer system according to clause 22 or clause 23, wherein the LLM is fine-tuned using a subset of annotated human decisions in relation to user requests.

25. A computer system according to any of clauses 22 to 24, wherein details of prior requests related to the current request are provided as an input to the LLM.

26. A computer system according to any preceding clause, wherein the program instructions are further configured to cause the one or more processors to transmit a notification to the user indicating whether access has been granted.

27. A computer system according to any preceding clause, wherein the service relates to an email system.

28. A computer system according to clause 27, wherein the service is transmission of an email to specified set of addresses.

29. A computer system according to clause 28, wherein the parameters include the addresses to which the user wishes to send an email.

30. A computer system according to any of clauses 27 to 29, wherein the parameters include the time of day of the request.

31. A computer system according any of clauses 27 to 30, wherein the parameters include the user's role or department in the organisation, and/or their length of service.

32. A computer system according any of clauses 27 to 31, wherein the parameters include the content of an email the user wishes to send.

33. A computer system according to clause 32, wherein the content of the email is analysed to determine if it is appropriate for the requested recipients.

34. A computer system according to clause 33, wherein the content is analysed using a large language model.

35. A computer system according to any of clauses 27 to 34, wherein the parameters include the frequency of the user's requests for access to the same or other services.

36. A computer system according to any of clauses 27 to 35, wherein the parameters include the size of a distribution list to which it is requested to send an email.

37. A computer system according to any of clauses 27 to 36, wherein the purpose of the email is determined by a language analysis of the content of the email.

38. A computer system according to any of clauses 27 to 37, wherein the parameters include previous requests and whether they were accepted or declined.

39. A computer system according to any of clauses 27 to 38, wherein the parameters include the urgency of the email, which may be determined by a language analysis of the content of the email.

40. A computer system according to any of clauses 27 to 39, wherein the parameters include information regarding attachments to the email.

41. A computer system according to any of clauses 27 to 40, wherein the parameters an indication of previous emails marked as inappropriate.

42. A computer system according to any of clauses 27 to 41, wherein the parameters include feedback on the user.

43. A computer system according to any of clauses 27 to 42, wherein the parameters include company policies regarding sending emails.

44. A computer system according to clause 1 or 3, wherein the service relates to a CRM system.

45. A computer system according to clause 44, wherein the service is access to the CRM system.

46. A computer system according to clause 44 or clause 45, wherein the parameters include the user's role or department in the organisation, and/or their length of service.

47. A computer system according to any of clauses 44 to 46, wherein the parameters include the frequency of the user's requests for access to the same or other services.

48. A computer system according to any of clauses 44 to 47, wherein the parameters include an indication whether the user is collaborating with other users who have access to the requested service.

49. A computer system according to any of clauses 44 to 48, wherein the parameters include the sensitivity of data accessible using the requested service.

50. A computer system according to any of clauses 44 to 49, wherein the parameters include the status of customers whose data is accessible using the requested service.

51. A computer system according to clause 1 or clause 3, wherein the service relates to a proxy service.

52. A computer system according to clause 51, wherein the parameters include the user's role or department in the organisation, and/or their length of service.

53. A computer system according to clause 51 or clause 52, wherein the parameters include the frequency of the user's requests for access to the same or other services.

54. A computer system according to any of clauses 51 to 53, wherein the parameters include an indication whether the user is collaborating with other users who have access to the requested service.

55. A computer system according to any of clauses 51 to 54, wherein the service relates to access to a specific site via the proxy service.

56. A computer system according to any of clauses 51 to 55, wherein the parameters include an indication whether peers have access to the site.

57. A computer system according to any of clauses 51 to 56, wherein the parameters include an indication of the site's reputation, category, and/or relevance to the user's role.

58. A computer system according to any of clauses 51 to 57, wherein the parameters include the content and/or terms & conditions of the site, which are analysed using a language analysis system and which may be a large language model.

59. A computer system according to any of clauses 51 to 58, wherein the parameters include past security incidents relating to the user.

60. A computer system according to any of clauses 51 to 59, wherein the parameters include an indication whether the user's device is sufficiently updated.

61. A computer system according to any of clauses 51 to 60, wherein the parameters include the time of the request.

62. A computer-implemented method for service security control, comprising: receiving, by a processor, user input requesting access to a service accessible from the processor, wherein the user input identifies the service and includes a natural language justification for requesting access; and performing, by the processor, a language analysis of the natural language justification and identify a similarity score between the natural language justification and parameters of the service to determine whether to grant access to the service.

63. A computer-implemented method according to clause 62, wherein the natural language justification comprises a description of what the user believes to be the functionality of the service.

64. A computer-implemented method according to clause 62 or clause 63, wherein the service relates to an email service.

65. A computer-implemented method according to clause 64, wherein the service is transmission of an email to specified set of addresses.

66. A computer-implemented method according to clause 64 or clause 65, wherein the parameters include the addresses to which the user wishes to send an email.

67. A computer-implemented method according to any of clauses 64 to 66, wherein the parameters include the time of day of the request.

68. A computer-implemented method according to any of clauses 64 to 67, wherein the parameters include the user's role or department in the organisation, and/or their length of service.

69. A computer-implemented method according to any of clauses 64 to 68, wherein the parameters include the content of an email the user wishes to send.

70. A computer-implemented method according to any of clauses 64 to 69, wherein the content of the email is analysed to determine if it is appropriate for the requested recipients.

71. A computer-implemented method according to any of clauses 64 to 70, wherein the content is analysed using a large language model.

72. A computer-implemented method according to any of clauses 64 to 71, wherein the parameters include the frequency of the user's requests for access to the same or other services.

73. A computer-implemented method according to any of clauses 64 to 72, wherein the parameters include the size of a distribution list to which it is requested to send an email.

74. A computer-implemented method according to any of clauses 64 to 73, wherein the purpose of the email is determined by a language analysis of the content of the email.

75. A computer-implemented method according to any of clauses 64 to 74, wherein the parameters include previous requests and whether they were accepted or declined.

76. A computer-implemented method according to any of clauses 64 to 75, wherein the parameters include the urgency of the email, which may be determined by a language analysis of the content of the email.

77. A computer-implemented method according to any of clauses 64 to 76, wherein the parameters include information regarding attachments to the email.

78. A computer-implemented method according to any of clauses 64 to 77, wherein the parameters an indication of previous emails marked as inappropriate.

79. A computer-implemented method according to any of clauses 64 to 78, wherein the parameters include feedback on the user.

80. A computer-implemented method according to any of clauses 64 to 79, wherein the parameters include company policies regarding sending emails.

81. A computer-implemented method according to clause 62 or clause 63, wherein the service relates to a CRM system.

82. A computer-implemented method according to clause 81, wherein the service is access to the CRM system.

83. A computer-implemented method according to clause 81 or clause 82, wherein the parameters include the user's role or department in the organisation, and/or their length of service.

84. A computer-implemented method according to any of clauses 81 to 83, wherein the parameters include the frequency of the user's requests for access to the same or other services.

85. A computer-implemented method according to any of clauses 81 to 84, wherein the parameters include an indication whether the user is collaborating with other users who have access to the requested service.

86. A computer-implemented method according to any of clauses 81 to 85, wherein the parameters include the sensitivity of data accessible using the requested service.

87. A computer-implemented method according to any of clauses 81 to 86, wherein the parameters include the status of customers whose data is accessible using the requested service.

88. A computer-implemented method according to clause 62, wherein the service relates to a proxy service.

89. A computer-implemented method according to clause 88, wherein the parameters include the user's role or department in the organisation, and/or their length of service.

90. A computer-implemented method according to clause 88 or clause 89, wherein the parameters include the frequency of the user's requests for access to the same or other services.

91. A computer-implemented method according to any of clauses 88 to 90, wherein the parameters include an indication whether the user is collaborating with other users who have access to the requested service.

92. A computer-implemented method according to any of clauses 88 to 91, wherein the service relates to access to a specific site via the proxy service.

93. A computer-implemented method according to any of clauses 88 to 92, wherein the parameters include an indication whether peers have access to the site.

94. A computer-implemented method according to any of clauses 88 to 93, wherein the parameters include an indication of the site's reputation, category, and/or relevance to the user's role.

95. A computer-implemented method according to any of clauses 88 to 94, wherein the parameters include the content and/or terms & conditions of the site, which are analysed using a language analysis system and which may be a large language model.

96. A computer-implemented method according to any of clauses 88 to 95, wherein the parameters include past security incidents relating to the user.

97. A computer-implemented method according to any of clauses 88 to 96, wherein the parameters include an indication whether the user's device is sufficiently updated.

98. A computer-implemented method according to any of clauses 88 to 97, wherein the parameters include the time of the request.

99. A computer-implemented method for service security control, comprising: receiving, by a processor, a request comprising the identity of a user requesting access to a service, an identity of the service, and a natural language justification for requesting access; performing, by the processor, a language analysis of the natural language justification and identify a similarity score between the natural language justification and parameters of the service; determining, by the processor, whether access should be granted to the service based at least in part on the similarity score; and configuring, by the processor, permissions for the service to enable access by the user when a determination is made to grant access.

100. A computer-implemented method according to clause 99, wherein the natural language justification comprises a description of what the user believes to be the functionality of the service.

101. A computer-implemented method according to clause 99 or clause 100, wherein the determination whether access should be granted is based at least in part on whether users related to the user have access to the service.

102. A computer-implemented method according to clause 101, wherein the users are related by being in a common group in a directory server.

103. A computer-implemented method according to clause 101 or clause 102, wherein relations between the users are determined based at least in part on communications between the users.

104. A computer-implemented method according to any of clauses 102 to 103, wherein relations between the users are determined based at least in part on organization data of an organization to which the users belong.

105. A computer-implemented method according to any of clauses 101 to 104, wherein relations between the users are determined based at least in part on interactions in workflow management systems.

106. A computer-implemented method according to any of clauses 101 to 105, wherein related users are based on access to the same services by the user and other users.

107. A computer-implemented method according to any of clauses 101 to 106, wherein the determination whether access should be granted is based at least in part on the user's access rights in relation to related services.

108. A computer-implemented method according to any of clauses 99 to 107, wherein the determination whether access should be granted is based at least in part on the user's role in an organization to which the object belongs.

109. A computer-implemented method according to any of clauses 99 to 108, wherein the determination whether access should be granted is based at least in part on a weighted score of a plurality of parameters including the similarity score.

110. A computer-implemented method according to any of clauses 99 to 109, wherein the score weightings are dependent on the service and/or user.

111. A computer-implemented method according to any of clauses 99 to 110, wherein the determination is based at least in part on previous network and service access by the user.

112. A computer-implemented method according to any of clauses 99 to 111, wherein when a determination is made to not grant access, transmitting, by the processor, a notification to the owner or creator of the service to take a decision.

113. A computer-implemented method according to any of clauses 99 to 112, wherein the user input and decision are written to an audit log.

114. A computer-implemented method according to any of clauses 99 to 113, wherein the determination is based at least in part on security settings of the service.

115. A computer-implemented method according to any of clauses 99 to 114, wherein the determination is based at least in part on a classification of the service, as determined by a classification engine.

116. A computer-implemented method according to any of clauses 99 to 115, wherein the classification is based on the sensitivity of data accessible by the requested service.

117. A computer-implemented method according to any of clauses 99 to 116, wherein the determination is based at least in part on a creator or owner of the service.

118. A computer-implemented method according to any of clauses 99 to 117, wherein information on which the determination is based is captured by the computer system and stored in at least one database for access by the computer system.

119. A computer-implemented method according to any of clauses 99 to 118, wherein information on which the determination is based is maintained on a continuous or intermittent basis by the computer system.

120. A computer-implemented method according to any of clauses 99 to 119, wherein the language analysis is performed by a Large Language Model (LLM).

121. A computer-implemented method according to clause 120, wherein the LLM is trained on prior human decisions in relation to user requests.

122. A computer-implemented method according to clause 120, wherein the LLM is fine-tuned using a subset of annotated human decisions in relation to user requests.

123. A computer-implemented method according to clause 122, wherein details of prior requests related to the current request are provided as an input to the LLM.

124. A computer-implemented method according to any of clauses 99 to 123, further comprising transmitting a notification to the user indicating whether access has been granted.

125. A computer-implemented method according to any of clauses 99 to 124, wherein the service relates to an email service.

126. A computer-implemented method according to clause 125, wherein the service is transmission of an email to specified set of addresses.

127. A computer-implemented method according to clause 125 or clause 126, wherein the parameters include the addresses to which the user wishes to send an email.

128. A computer-implemented method according to any of clauses 125 to 127, wherein the parameters include the time of day of the request.

129. A computer-implemented method according to any of clauses 125 to 127, wherein the parameters include the user's role or department in the organisation, and/or their length of service.

130. A computer-implemented method according to any of clauses 125 to 127, wherein the parameters include the content of an email the user wishes to send.

131. A computer-implemented method according to any of clauses 125 to 130, wherein the content of the email is analysed to determine if it is appropriate for the requested recipients.

132. A computer-implemented method according to clause 131, wherein the content is analysed using a large language model.

133. A computer-implemented method according to any of clauses 125 to 132, wherein the parameters include the frequency of the user's requests for access to the same or other services.

134. A computer-implemented method according to any of clauses 125 to 133, wherein the parameters include the size of a distribution list to which it is requested to send an email.

135. A computer-implemented method according to any of clauses 125 to 134, wherein the purpose of the email is determined by a language analysis of the content of the email.

136. A computer-implemented method according to any of clauses 125 to 135, wherein the parameters include previous requests and whether they were accepted or declined.

137. A computer-implemented method according to any of clauses 125 to 136, wherein the parameters include the urgency of the email, which may be determined by a language analysis of the content of the email.

138. A computer-implemented method according to any of clauses 125 to 137, wherein the parameters include information regarding attachments to the email.

139. A computer-implemented method according to any of clauses 125 to 138, wherein the parameters an indication of previous emails marked as inappropriate.

140. A computer-implemented method according to any of clauses 125 to 139, wherein the parameters include feedback on the user.

141. A computer-implemented method according to any of clauses 125 to 140, wherein the parameters include company policies regarding sending emails.

142. A computer-implemented method according to clause 99, wherein the service relates to a CRM system.

143. A computer-implemented method according to clause 142, wherein the service is access to the CRM system.

144. A computer-implemented method according to clause 142 or clause 143, wherein the parameters include the user's role or department in the organisation, and/or their length of service.

145. A computer-implemented method according to any of clauses 142 to 144, wherein the parameters include the frequency of the user's requests for access to the same or other services.

146. A computer-implemented method according to clauses 142 to 145, wherein the parameters include an indication whether the user is collaborating with other users who have access to the requested service.

147. A computer-implemented method according to clauses 142 to 146, wherein the parameters include the sensitivity of data accessible using the requested service.

148. A computer-implemented method according to clauses 142 to 147, wherein the parameters include the status of customers whose data is accessible using the requested service.

149. A computer-implemented method according to clause 99, wherein the service relates to a proxy service.

150. A computer-implemented method according to clause 149, wherein the parameters include the user's role or department in the organisation, and/or their length of service.

151. A computer-implemented method according to clause 149 or clause 150, wherein the parameters include the frequency of the user's requests for access to the same or other services.

152. A computer-implemented method according to any of clauses 149 to 151, wherein the parameters include an indication whether the user is collaborating with other users who have access to the requested service.

153. A computer-implemented method according to any of clauses 149 to 152, wherein the service relates to access to a specific site via the proxy service.

154. A computer-implemented method according to clause 153, wherein the parameters include an indication whether peers have access to the site.

155. A computer-implemented method according to clause 153 or clause 154, wherein the parameters include an indication of the site's reputation, category, and/or relevance to the user's role.

156. A computer-implemented method according to any of clauses 153 to 155, wherein the parameters include the content and/or terms & conditions of the site, which are analysed using a language analysis system and which may be a large language model.

157. A computer-implemented method according to any of clauses 149 to 156, wherein the parameters include past security incidents relating to the user.

160. A computer-implemented method according to any of clauses 149 to 157, wherein the parameters include an indication whether the user's device is sufficiently updated.

161. A computer-implemented method according to any of clauses 149 to 158, wherein the parameters include the time of the request.

1. A computer system for a security control, comprising:
one or more computer readable storage media storing program instructions and one or more processors which, in response to executing the program instructions, are configured to:
receive user input requesting access to a service provided by the computing system, wherein the user input identifies the service and includes a natural language justification for requesting access;
perform a language analysis of the natural language justification and identify a similarity score between the natural language justification and parameters of the service;
determine whether access should be granted to the service based at least in part on the similarity score; and
configure permissions for the service to enable access by a user when a determination is made to grant access.

2. A computer system according to claim 1, wherein the natural language justification comprises a description of what the user believes to be the functionality of the service.

3. A computer system according to claim 1, wherein the determination whether access should be granted is based at least in part on whether users related to the user have access to the service.

4-5. (canceled)

6. A computer system according to claim 3, wherein the relations between the users are determined based at least in part on organization data of an organization to which the users belong.

7-8. (canceled)

9. A computer system according to claim 1, wherein the determination whether access should be granted is based at least in part on the user's access rights in relation to related services.

10. A computer system according to claim 1, wherein the determination whether access should be granted is based at least in part on the user's role in the organization which provides the service or the organisation to which the user belongs.

11-26. (canceled)

27. A computer system according to claim 1, wherein the service relates to an email system.

28. A computer system according to claim 27, wherein the service is transmission of an email to specified set of addresses.

29. A computer system according to claim 27, wherein the parameters include the addresses to which the user wishes to send an email.

30. A computer system according to claim 27, wherein the parameters include the time of day of the request.

31. A computer system according to claim 27, wherein the parameters include the user's role or department in the organisation, and/or their length of service.

32. A computer system according to claim 27, wherein the parameters include the content of an email the user wishes to send.

33. A computer system according to claim 31, wherein the content of the email is analysed to determine if it is appropriate for the requested recipients.

34. A computer system according to claim 33, wherein the content is analysed using a large language model.

35. (canceled)

36. A computer system according to claim 27, wherein the parameters include the size of a distribution list to which it is requested to send an email.

37. A computer system according to claim 27, wherein the purpose of the email is determined by a language analysis of the content of the email.

38. (canceled)

39. A computer system according to claim 28, wherein the parameters include the urgency of the email, which may be determined by a language analysis of the content of the email.

40. A computer system according to claim 28, wherein the parameters include information regarding attachments to the email.

41. A computer system according to claim 27, wherein the parameters an indication of previous emails marked as inappropriate.

42-43. (canceled)

44. A computer system according to claim 1, wherein the service relates to a CRM system.

45. A computer system according to claim 44, wherein the service is access to the CRM system.

46. A computer system according to claim 44, wherein the parameters include the user's role or department in the organisation, and/or their length of service.

47. (canceled)

48. A computer system according to claim 44, wherein the parameters include an indication whether the user is collaborating with other users who have access to the requested service.

49. A computer system according to claim 44, wherein the parameters include the sensitivity of data accessible using the requested service.

50. A computer system according to claim 44, wherein the parameters include the status of customers whose data is accessible using the requested service.

51. A computer system according to claim 1, wherein the service relates to a proxy service.

52. A computer system according to claim 51, wherein the parameters include the user's role or department in the organisation, and/or their length of service.

53-54. (canceled)

55. A computer system according to claim 51, wherein the service relates to access to a specific site via the proxy service.

56. (canceled)

57. A computer system according to claim 55, wherein the parameters include an indication of the site's reputation, category, and/or relevance to the user's role.

58. A computer system according to claim 55, wherein the parameters include the content and/or terms & conditions of the site, which are analysed using a language analysis system and which may be a large language model.

59. A computer system according to claim 51, wherein the parameters include past security incidents relating to the user.

60. A computer system according to claim 51, wherein the parameters include an indication whether the user's device is sufficiently updated.

61. A computer system according to claim 51, wherein the parameters include the time of the request.

62. A computer-implemented method for service security control, comprising:
receiving, by a processor, user input requesting access to a service accessible from the processor, wherein the user input identifies the service and includes a natural language justification for requesting access; and
performing, by the processor, a language analysis of the natural language justification and identify a similarity score between the natural language justification and parameters of the service to determine whether to grant access to the service.

63-98. (canceled)

99. A computer-implemented method for service security control, comprising:
receiving, by a processor, a request comprising the identity of a user requesting access to a service, an identity of the service, and a natural language justification for requesting access;
performing, by the processor, a language analysis of the natural language justification and identify a similarity score between the natural language justification and parameters of the service;
determining, by the processor, whether access should be granted to the service based at least in part on the similarity score; and
configuring, by the processor, permissions for the service to enable access by the user when a determination is made to grant access.

100-159. (canceled)
